(19) United States
(12) Patent Application Publication
(10) Pub. No.: US 2008/0221747 A1
(43) Pub. Date: Sep. 11, 2008

(54) Control System For a Motor Vehicle

(75) Inventors: Markus Baumann, Stuttgart (DE); Manfred Dorn, Stuttgart (DE); Volker Hellwig, Stuttgart (DE); Carla Knoop, Stuttgart (DE); Guenter Metsch, Moeglingen (DE); Jochen Moritz, Ingolstadt (DE); Armin Zachay, Rechberghausen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/584,125

(22) PCT Filed: Nov. 25, 2004
(86) PCT No.: PCT/EP04/13363

§ 371 Date: Oct. 26, 2007

(30) Foreign Application Priority Data
Dec. 23, 2003 (DE) 103 60 657.2

(51) Int. Cl. G06F 17/00

(52) U.S. Cl. 701/29; 701/1

(57) ABSTRACT

A control system for a motor vehicle having a manual actuating device with a plurality of degrees of freedom of adjustment for selecting and/or activating entries from a menu structure and a screen display (2) having a plurality of display areas (210 to 250) for displaying the menu structure, the display areas (210 to 250) each comprising at least one field for displaying one of the entries. In an activated display area (210 to 250) in at least one menu level, a first and/or a second of the plurality of degrees of freedom of adjustment of the manual actuating means for selecting and/or activating one of the entries corresponds to an orientation of the displayed entries, and a third and/or fourth degree of freedom of adjustment of the manual actuating device for exiting the active display area (210 to 250) is respectively orthogonal to the orientation of the displayed entries.

### BACKGROUND AND SUMMARY OF THE INVENTION

The invention relates to a control system for a motor vehicle.

In modern vehicles, multimedia control systems are being increasingly used. An example of this is the command system in the Mercedes Benz S-class.

German Patent Document DE 197 52 056 A1 describes a control system of the generic type, in particular for a motor vehicle. In this control system, two display areas are displayed on a screen display in a menu structure with a plurality of menu levels. A first display area is arranged as a frame around the second display area. In a first menu level, eight fields with entries which correspond to applications which can be carried out and which are arranged vertically and horizontally are displayed in the first display area. An entry is selected by pushing or tilting movement of the manual actuating device with a plurality of degrees of freedom of adjustment in the direction of the position of the corresponding entry in the first display area. A selected entry is activated by pressing the manual actuating device. After the activation, a plurality of vertically arranged entries which are assigned to the activated entry in the first menu level are displayed in a second menu level in the second display area. The entries displayed in the second display area are selected by rotational movement of the manual actuating device and activated by pressing the manual actuating device. The activated second display area and the second menu level are exited by pushing or tilting movement of the manual actuating means in the direction of a position of one of the entries in the first display area. The control system is then located in the first menu level in the first display area again.

The object of the invention is to specify an improved control system for a motor vehicle which permits intuitive control and which reduces the scope of distracting information.

The invention is based on the idea of providing, in an actuating device for selecting and/or activating entries in a respectively active display area, degrees of freedom of adjustment whose direction of movement corresponds to an orientation of the entries displayed in the active display area, and to provide, for the purpose of exiting the active display area, degrees of freedom of adjustment whose direction of movement is orthogonal with respect to the orientation of the entries displayed in the active display area.

The inventive assignment of the degrees of freedom of adjustment of the manual actuating device to the orientation of the arrangement of the entries permits intuitive operator control of the respective active display area and intuitive exiting of the active display area. As a result, the control processes for the user are simplified and the cognitive load is reduced so that the user can concentrate better on the events on the road.

In one advantageous development of the invention, a fifth and/or sixth degree of freedom of adjustment of the manual actuating device can be provided for redundantly selecting the at least one entry displayed in the active display area. As a result of the additional degrees of freedom of adjustment for redundant selection, the probability of incorrect operation is reduced further and the intuitive operator control is improved further.

The fields with the entries can be arranged vertically and/or horizontally in the individual display areas.

The activation of a selected entry can be carried out for example, by a seventh degree of freedom of adjustment of the manual actuating means and/or as a function of a current system state which is determined by a control and evaluation unit. These vehicle systems comprise, for example, a navigation system with a locating unit, a heating system and air conditioning system, a cellular telephone, a video system, an audio system etc.

In order to give the display areas visually clear configuration, when there are a plurality of entries in a display area, the width of the individual fields when the entries are arranged horizontally can be made adjustable in a variable fashion on the length of the respective entry, and when the entries are arranged vertically said width can be made adjustable in a variable fashion on the length of the longest entry.

Alternatively or additionally, the field width when entries are arranged horizontally can be dependent on the number of entries to be displayed in this display area.

In order to enhance the effect of intuitive control, in one advantageous development of the invention the screen display can comprise at least a first display area which has a constant graphic basis structure over all the menu levels of the menu structure, that is to say the entries in this at least one display area have a constant horizontal and/or vertical arrangement over all the menu levels.

In order to control the various applications in a detailed fashion it is possible to provide at least a second display area on the screen display, which second display area has a variably adjustable graphic basic structure as a function of an active menu level of the menu structure.

In one advantageous configuration of the invention, as a function of an activation of one of the entries in the individual menu levels of the menu structure, submenus which are dependent on this entry in at least one further level of the menu structure can be opened, and by activating at least one of the display areas can be displayed in said area.

The opened submenu can, for example, be displayed only in the active display area or in at least one other of the display areas by an overlap of the graphic basic structure.

A plurality of submenus, preferably two, can be displayed simultaneously on the screen display in the at least one further menu level of the menu structure.

When the entries are orientated vertically in the submenus, the plurality of submenus can, for example, be displayed one next to the other.

In one advantageous configuration of the invention, a first of the plurality of submenus can be opened and displayed in the first menu level of the menu structure as a function of an activation of an entry, and a second of the plurality of submenus can be opened and displayed as a function of an activation of an entry in the associated first submenu.

The opened submenus can be closed simultaneously, for example, by pushing the manual actuating device orthogonally with respect to the orientation of the entries of the active submenu away from the adjacent submenu. Furthermore, it is possible to provide that only the active, i.e. the second submenu is closed, and the adjacent, i.e. the first submenu for a new selection of an entry, is activated by pushing the manual actuating device orthogonally with respect to the orientation of the entries of the active submenu in the direction of the adjacent submenu.

The number and/or the graphic display and/or contents of the entries to be displayed in the display areas can be variable and/or constant as a function of current system states, such as for example a passenger compartment temperature which is currently determined by sensors of the heating system and air conditioning system, a determined reception strength of an antenna for the cellular telephone, the fact that a position predefined in the navigation system is reached etc., and/or of a current menu level and/or of a currently activated application.

A presettable application can be displayed in at least one of the first display areas, the number and the position of the entries to be displayed being constant as a function of the preset application, and the contents and the graphic display of the entries to be displayed being variable and/or constant as a function of current system states.

In one advantageous configuration, at least one of the first display areas is configured as a status bar with at least one horizontally arranged field for displaying at least one status. The number, the position, the contents and the graphic display of the entries to be displayed are variable as a function of current system states and/or application states.

At least one of the first display areas can be configured as an application line for displaying an application group with various selectable and predefinable applications, in particular an audio application, navigation application, communications application, video application and vehicle application. The number and position of the entries to be displayed are constant, and the graphic display of the entries to be displayed is configured in a variable manner as a function of an activated application.

At least one of the second display areas can be configured as an application area for displaying details and controlling a selected and activated application. The number and the position and the graphic display of the entries to be displayed are dependent on the activated application.

At least one of the first display areas can be configured as a subfunction line for displaying and selecting functions and/or subfunctions and/or options of an activated application. The number and the position and the graphic display of the entries to be displayed are independent on the activated application.

In order to select at least one entry which is displayed on the screen display, a cursor can be moved over the screen display using the manual actuating device.

The graphic display of the cursor is dependent, for example, on the active display area and/or on an active application and/or on an active menu level.

The cursor may be displayed graphically, for example, as an independent object on the screen display or by changing the graphic display of a current selected field.

Advantageous configurations of the invention are displayed in the drawings and are described below.

### BRIEF DESCRIPTION OF THE DRAWINGS

FIG. 1 is a block circuit diagram of a control system for a motor vehicle;

FIGS. 2a and 2b are each a schematic illustration of a screen display from FIG. 1 in a first menu level;

FIG. 2c is a schematic illustration of the screen display from FIG. 1 in a second menu level;

FIG. 2d is a schematic illustration of the screen display from FIG. 1 in a third menu level;

FIG. 2e is a schematic illustration of the screen display from FIG. 1 in a further menu level;

FIG. 3 is a schematic illustration of the screen display from FIG. 1 with entries in the enu level from FIG. 2e which are adapted to the control for a motor vehicle;

FIG. 4 is a schematic, alternative illustration of the screen display from FIG. 1 in the second menu level;

FIGS. 5a to 5c are each a schematic illustration of the screen display from FIG. 1 showing a submenu closing process;

FIGS. 6a and 6b are each a first schematic illustration of submenus on the screen display from FIG. 1;

FIGS. 7a and 7b are each a second schematic illustration of submenus on the screen display from FIG. 1;

FIGS. 8a to 8c are each a third schematic illustration of submenus on the screen display from FIG. 1; and

FIG. 9 is a schematic illustration of the screen display from FIG. 1 in a further submenu.

### DETAILED DESCRIPTION OF THE DRAWINGS

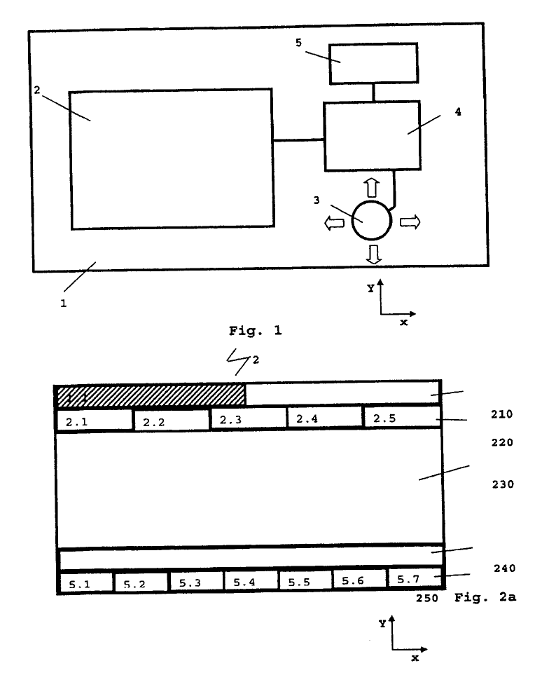

As is apparent from FIG. 1, the control system 1 for a motor vehicle comprises a screen display 2, a manual actuating device 3, a control and evaluation unit 4 and a plurality of vehicle systems such as a navigation system, a heating system and an air conditioning system, a cellular telephone, a video system, an audio system etc. which are illustrated combined as one element 5. The vehicle systems transmit signals to the evaluation and control unit 4 from which the control and evaluation unit 4 determines current system states. All the applications and/or functions and/or subfunctions and/or options and/or status displays in various menu levels of a menu structure are controlled by means of the manual actuating device 3. The latter has seven degrees of freedom of adjustment for selecting and/or activating entries displayed in an active display area. Said actuating device 3 can be pushed in four directions according to the arrow illustration in FIG. 1, i.e. in a positive x direction, a negative x direction, in a positive y direction or in a negative y direction. In addition, it can be rotated in the clockwise direction or in the counter clockwise direction about a z axis (not illustrated) which is perpendicular to the plane of the drawing, and can be pressed in the direction of the negative z direction, i.e. into the plane of the drawing.

Rotating the manual actuating device 3 in the clockwise direction causes a cursor on the screen 2 to move to the right or downward as a function of a horizontal or vertical orientation of the entries displayed on the screen display 2, and turning in the counter clockwise direction causes the cursor to move to the left or upward. Pushing the manual actuating device 3 in FIG. 1 upward, i.e. forward in the direction of the windshield, i.e. in the positive y direction, causes the cursor on the screen display 2 to move upward, and the pushing process in the downward direction in FIG. 1, i.e. toward the rear in the negative y direction, causes the cursor on the screen display 2 to move downward. Pushing to the right, i.e. in the positive x direction, causes the cursor on the screen display 2 to move to the right, and pushing to the left, i.e. in the negative x direction, causes the cursor to move to the left.

The selection and/or activation of an entry displayed on the screen display 2 are carried out by pushing or turning the manual actuating device 3. In a redundant fashion with respect to the vertical pushing along an axis, i.e. with respect to the pushing in the y direction, or with respect to the horizontal pushing along an axis, i.e. with respect to the pushing in the x direction, it is possible to rotate the manual actuating device 3 about the z axis. The pushing movement in order to select an entry corresponds here according to the invention to the orientation of the entries displayed in the active display area. The pushing direction which is respectively orthogonal with respect to the selection pushing direction causes the active display area to be exited. In addition, in order to activate a selected entry it may be necessary to press the manual actuating means 3.

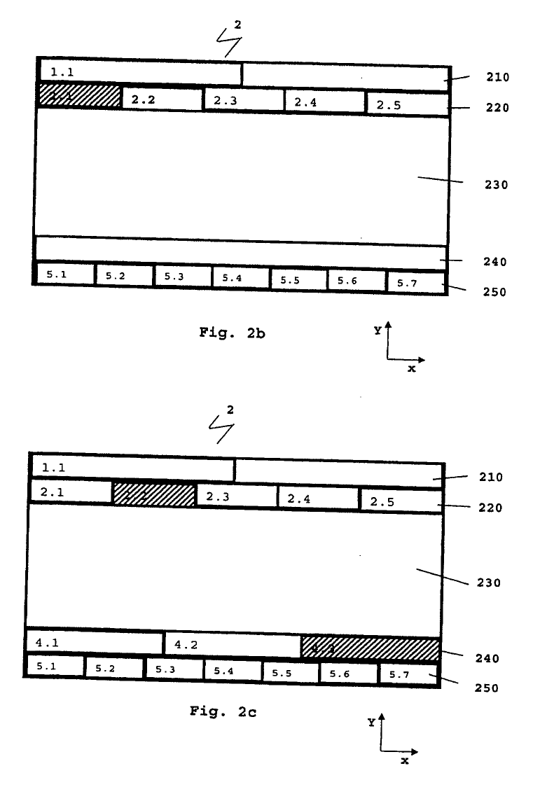

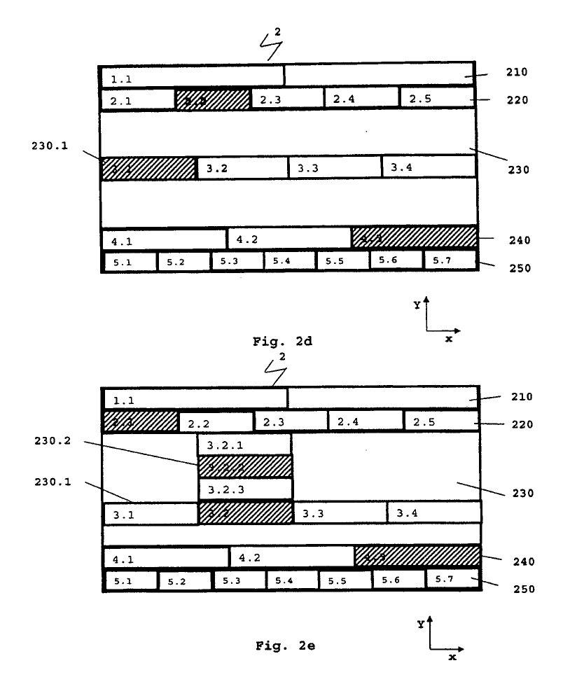

As is clear from FIG. 2a, the screen display 2 comprises, in a first menu level, a graphic basic structure of five vertically arranged, horizontal display areas 210 to 250. This graphic basis structure is constant over the multiplicity of various menu levels of the menu structure. The screen display 2 is configured, for example, as an eight inch screen with a ratio of the sides of 15:9. The graphic basic structure of at least a first of the display areas 210 to 250 of the screen display 2 is constant over the multiplicity of various menu levels of the menu structure. In FIG. 2a, the display areas 210, 220, 240 and 250 are configured as such first display areas.

The graphic basis structure of at least a second of the display areas 210 to 250 is variable over the multiplicity of various menu levels of the menu structure as a function of an activated application and/or function and/or subfunction and/or option and/or status display. In FIG. 2a, the display area 230 is configured as such as second display area. This central display area 230 may be configured graphically in very different ways.

One or more horizontally arranged entries 1.1 to 5.7 may be respectively displayed in the four display areas 210, 220, 240 and 250 which are configured as first display areas. For example, the display areas 210, 220, 240 and 250 in FIG. 2a in the first menu level each comprise a different number of entries. For example, the first display area 210 comprises an entry 1.1, the second display area 220 comprises five entries 2.1 to 2.5, the fourth display area comprises no entry and the fifth display area comprises seven entries 5.1 to 5.7. In FIG. 2a, the first display area 210 is activated and the hatched entry 1.1. is selected. The hatched display is intended to indicate that the cursor is positioned on the entry 1.1.

The entries 1.1 to 5.7 of the display areas 210 to 250 displayed on the screen display 2 can be arranged according to the importance of their contents or their frequency of application.

FIG. 2b shows the screen display 2 in the first menu level after the actuating device 3 has been pushed from the display state in FIG. 2a in the negative y direction or has been rotated clockwise. Specifically, as a result of this the second display area 220 in FIG. 2b is active and the entry 2.1 is selected.

FIG. 2c shows the screen display 2 in a second menu level after the entry 2.2 in the second display area 220 has been selected by pushing the manual actuating means 3 in the positive x direction, and has been activated by pressing the manual actuating means 3. The activation of the entry 2.2 activates the second menu level and the fourth display area 240 in which three horizontally arranged entries 4.1 to 4.3 are displayed. The entries 4.1 to 4.3 are assigned to the entry 2.2 of the second display area 220 and can be selected with the manual actuating device 3. The entry 4.3 is selected in FIG. 2c. The active state of the entry 2.2 and the selected state of the entry 4.3 are indicated by the hatched display.

FIG. 2d shows the screen display 2 in a third menu level after the entry 4.3 in the fourth display area 240 has been activated by pressing the manual actuating means 3. Activating the entry 4.3 activates the third menu level and the third display area 230 in which a submenu in the form of a further display area 230.1 with four horizontally arranged entries 3.1 to 3.4 is then opened, activated and displayed. The opened submenu 230.1 and thus the entries 3.1 to 3.4 are assigned to the entry 4.3 of the fourth display area. The entries 3.1 to 3.4 can be selected with the manual actuating device 3. In FIG. 2d, the entry 3.1 is selected. The active state of the entries 2.2 and 4.3 and the selected state of the entry 3.1 are indicated by the hatched display.

FIG. 2e shows the screen display 2 in a further menu level after the entry 3.2 in the third display area 230 has been activated by pushing in the x direction and by pressing the manual actuating device 3. Activating the entry 3.2 activates the further menu level and a further display area 230.2 within the third display area 230. The display area 230.2 is configured as a further submenu in the form of a vertical list with entries 3.2.1 to 3.2.3. The opened submenu 230.2 and thus the entries 3.2.1 to 3.2.3 are assigned to the entry 3.2 in the submenu 230.1 of the third display area 230. The entries 3.2.1 to 3.2.3 can be selected with the manual actuating device 3. In FIG. 2e, the entry 3.2.2 is selected. The active state of the entries 2.2, 4.3 and 3.2 and the selected state of the entry 3.2.2 are indicated by the hatched display.

FIG. 3 shows a schematic illustration of the screen display 2 from FIG. 1 with specific entries in the menu level from FIG. 2e which have been adapted to the control for a motor vehicle. As is apparent from FIG. 3, the first display area 210 is configured as a status line which presents various status displays S1 to S7 from different applications. The main function of the status line is to display important current system states which are determined by the control and evaluation unit 4 as a function of signals from the vehicle systems 5. The entries or status displays S1 to S7 can be selected and activated with the manual activating means 3. In order to determine the current system states, for example the signals from the navigation system with a locating unit, from the heating and air conditioning system, from the cellular telephone, from the video system, from the audio system, etc. are evaluated. In the status line it is indicated, for example, whether a traffic radio transmitter is activated, whether the heating and air conditioning system is operating in recirculation mode or fresh air mode, whether the activated carbon filter is activated etc.

The first display area 210 which is embodied as a status line may contain a plurality of controllable and noncontrollable entries 1.1, S1 to S7 which are included in the display or removed from it as a function of the system state. The possibility of controlling some entries can permit direct access to important functions without making it necessary to change the application. If an entry is selected from the status line, this can lead directly to an associated function. For example, by actuating a letter symbol a display area in a ComTel application, i.e. in a communications application or telephone application, can be activated and opened. Activating a telephone receiver symbol can activate and open another display area in the ComTel application group. Activating a TP symbol deactivates a traffic program, i.e. a traffic radio transmitter. In addition, various nonselectable status displays such as a satellite key for displaying the GPS reception or a field strength can be provided.

The second display area 220 is configured as an application line for displaying an application group with various selectable and predefinable applications Appl. 1 to Appl. 5, in particular an audio application, navigation application, communications application, video application and a vehicle application, the number and position of the entries to be displayed, i.e. if the applications Appl. 1 to Appl. 5, being constant and the graphic display of the entries to be displayed being variable as a function of an activated application. Activating one of the applications Appl. 1 to Appl. 5 which is not already active brings about a changeover into the associated application and activates the fourth display area 240 for displaying subfunctions SubF 1 to SubF 3 which are associated with the active application. If an application does not have subfunctions, the third display area 230 can be activated by activating this application in the second display area 220, and the options relating to control which are associated with this application are displayed.

The arrangement of the application groups in the second display area 220 is constant and can be ordered from left to right according to the frequency of use of importance. Selecting an application or application group causes at least one other display area to be activated directly.

The third display area 230 is configured as an application area for displaying details and controlling a selected and activated application. The number and position and the graphic display of the entries to be displayed, in this case of options Opt. 3.1 to Opt. 3.4 and Opt. 3.2.1 to Opt. 3.2.3 are dependent on the activated application Appl. 1 to Appl. 5. The graphic display and controllability of the third display area 230 is variable and can therefore be satisfactorily adapted to a greatly varying functionality or requirements of the various applications Appl. 1 to Appl. 5.

The fourth display area 240 is configured as a subfunction line for displaying and selecting functions and/or subfunctions and/or options of an activated application Appl. 1 to Appl. 5. The number and position and the graphic display of the entries to be displayed, i.e. for the subfunctions SubF 1 to SubF 3, are dependent on the activated application Appl. 1 to Appl. 5. The graphic basic structure is constant over all the menu levels of the menu structure.

The fifth display area 250 is configured as a main application line. A presettable application can be displayed in this display area 250. The number and the position of the entries HA1 to HA7 to be displayed are constant for the preset application, and the contents and the graphic display of the entries HA 1 to HA 7 to be displayed are variable and/or constant as a function of current system states. The preset application is preferably used to control an air conditioning system in the vehicle. The graphic display of the entries HA1 to HA7 is provided in the form of icons. The position and number of these icons are constant. The displayed values of a set parameter such as, for example, air temperature, blower strength etc. may vary. The current system states relate in particular to relevant states for controlling the temperature in the passenger compartment of the vehicle such as, for example, external temperature, intensity of solar radiation, temperature of the passenger compartment, air humidity etc.

In the screen display 2 illustrated in FIG. 3, the second application Appl. 2, the third subfunction SubF 3 and the second option 3.2 are activated and the option 3.2.2 is selected, which is indicated by hatched display of the corresponding fields.

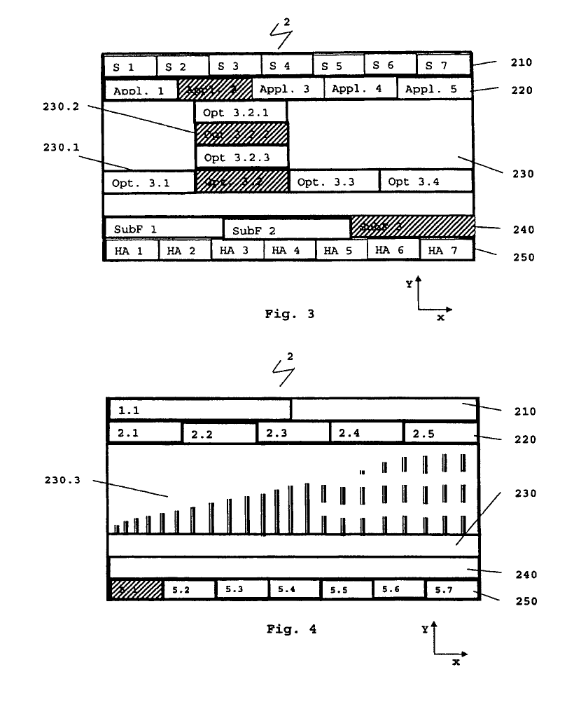

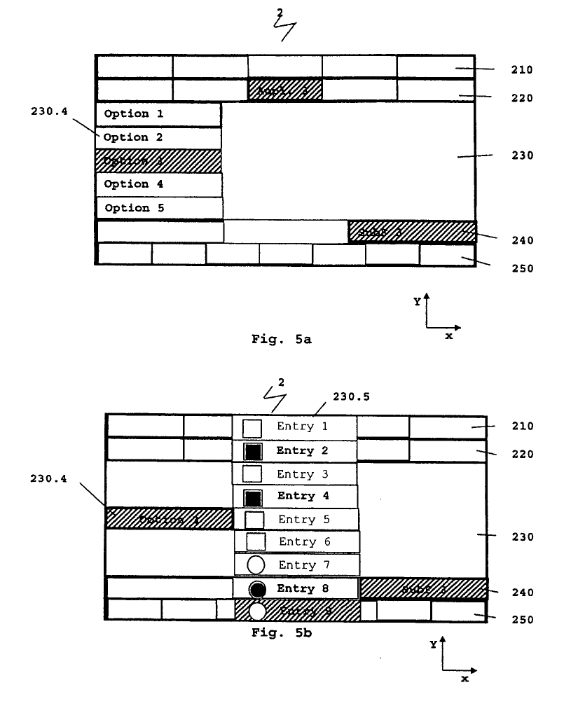

FIG. 4 shows a further display of the screen display 2 in the second menu level. In contrast to FIG. 2c, the fifth display area 250 in FIG. 4 is active and entry 5.1 is activated. Activating the entry 5.1 activates the third display area 230 with a further display area 230.3. The latter serves to set a horizontally arranged parameter. The parameter is set by pushing the manual actuating means 3 in the x direction or by rotating it about the z axis. The instantaneously set parameter value is determined by the last continuous vertical bar. The vertical bars which are displayed as dashes indicate further possible settable parameter values. The settable parameter is, for example, a desired temperature of the passenger compartment. The vertical bars then correspond to various temperature values.

Basically, all the displayed entries 1.1 to 5.7 can be selected with the manual actuating device 3. Only a small number of status displays and options which are not available at certain times are exempted. It is not possible to select all the displayed entries by rotating. In each display area 210 to 250 only a number of correspondingly graphically highlighted elements can be selected directly by rotation. The other entries are firstly activated by pushing the manual actuating means 3 orthogonally with respect to the graphically highlighted area. The activity state, i.e. the possibility of directly selecting a display area 210 to 250 or individual entries is displayed, for example, by different colouring and graphic elements.

In at least one of the display areas 210 to 220, the cursor is not an independent object on the screen display 2 but rather assumes the shape of the field in which it is positioned. In the described configuration, this applies to the first, second, fourth and fifth display areas 210, 220, 240, 250. The cursor is displayed by changing the graphic display of the field on which it is positioned, for example by changing the colour of the background of the respective entry 1.1 to 5.7, with the inversion of the colours of the display of the entry 1.1 to 5.7. The positioning of the cursor on a field represents the selection of the entry associated with this field. It is possible to depart from this display if a parameter setting can already be implemented by rotating or pushing the cursor, or if the entry is displayed graphically instead of as text. In this case, the cursor is displayed with a different graphic form. This type of cursor display can be limited spatially to the third display area 230.

The width of the cursor in the horizontally orientated display areas 210, 220, 240, 250 corresponds to the width of a field with an entry and can be determined, for example, according to the number of entries 1.1 to 5.7 in the respective display area 210, 220, 240, 250. When there are one or two entries 1.1 to 5.7 in the respective display area 210, 220, 240, 250, the field, and thus cursor can assume half the width of the screen display 2. When there are more than two entries in one of the horizontally orientated display areas 210, 220, 240, 250, the screen display 2 can be divided among the fields with entries, the field width of the individual fields and the thus the cursor width being adapted to the width of the entries in the individual fields. The screen display 2 is generally divided in such a way that the fields with entries are directly adjacent to one another.

In vertically orientated display areas which are configured, for example as lists or submenus, the field width and thus the cursor width corresponds to the width of the list, the width of the list being determined, for example, by the longest entry in the list.

The cursor is always positioned within what is referred to as an active display area 210 to 250, i.e. in a display area 210 to 250 which can be controlled directly and in which one of the entries can be selected and/or activated by rotating and pushing the manual actuating device 3 either horizontally or vertically as a function of the orientation of the entries 1.1 to 5.7. This active display area 210 to 250 is orientated either vertically or horizontally.

The entries of the active display area 210 to 250 can be highlighted through colour, for example by a light script and/or icons and/or graphics on a dark background. In addition, this display area can be delimited by a horizontal or vertical light line which serves, for example, to indicate the direction of rotation. In the third display area 230, the activation state can be displayed by means of a highlighted entry and/or by means of the highlighted cursor.

The display areas 210 to 250 which are not directly active can be displayed in a graphically subdued fashion, for example by means of a different colour and/or different intensity. These unactivated displayed areas 210 to 250 can be selected by respectively orthogonally pushing the manual actuating means 3 with respect to the orientation of the entries in the active display area 210 to 250.

Entries which cannot be selected for a certain time can nevertheless be displayed, for example, in an attenuated form with colour contrast. The cursor cannot be moved onto such entries. These entries can, for example, be jumped over or the movement of the manual actuating means 3 can be limited, for example, in the form of a stop, which prevents the cursor being moved onto the field which cannot be selected.

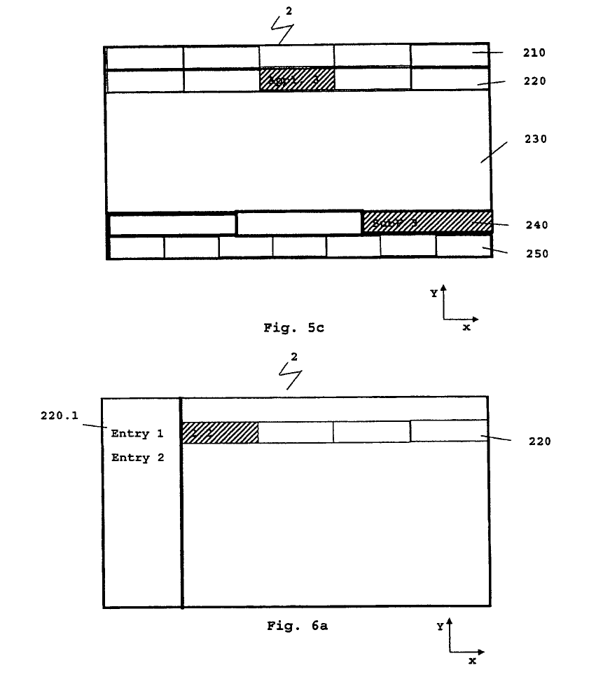

FIG. 5a shows the screen display 2 in the third menu level with an opened submenu 230.4 within the third display area 230. In the illustrated submenu 230.4, an option 3 is selected. Submenu 230.40 is assigned to the subfunction SubF 3 which is assigned to the application Appl. 3.

FIG. 5b shows the screen display 2 in a fourth menu level which is activated by activating an option 3 in the submenu 230.4 from FIG. 5a. A further submenu 230.5 is opened and activated in FIG. 5b. As is apparent from FIG. 5b, the submenu can extend over the full height of the screen display 2. If a submenu is configured as a list with text entries, the number of the entries can be unlimited, the number of entries which can be viewed at maximum being limited, for example to nine entries. When there are more than nine entries, an entry can be selected by scrolling. The indication that further entries which cannot be viewed are present can be provided by means of arrows.

The selection of the first submenu 230.4 which is illustrated in FIG. 5a changes the colour and/or graphic representation of the display areas 210 to 250 on the screen display 2. The position of the cursor on the screen display 2 is displayed graphically by means of colour. The display area 240 from which the first submenu 230.4 has been called is subdued in terms of colour compared to the active display area 230. All the other display areas 210, 220, 240 and 250 are graphically in the background. This principle is maintained when further submenus 230.5 from FIG. 5b are opened, i.e. the entire path is indicated by colour, while the other options are subdued graphically. The path is highlighted in the figures in each case by means of the hatched display of the corresponding selected or activated entries. This display principle is used to indicate the entries which the user accesses if he respectively pushes the control element 3 orthogonally with respect to the active display area in the direction from which the menu is opened.

The possible activation states of the display areas 210 to 250 comprise and display a directly controllable display area, a display area from which an active display area has been called and all the other display areas.

Entries 1 to 9 in the submenu list 230.5 show further display possibilities of activation states of functions. The entries 1 to 6 comprise selection boxes which indicate whether or not the corresponding entry is activated. The entries 1 to 6 may be activated independently of one another. Pressing the manual actuating device 3 causes the box to be filled with a square, and pressing the manual actuating device 3 again deletes the square from the box and deactivates the associated entry 1 to 6.

The displayed entries 7 to 9 can only be activated in an exclusively individual fashion. The activation state is displayed by a filled-in circle. The activation can also be carried out by pressing the manual actuating means 3.

The activated submenu is exited, for example, by activating an entry with deletion of the function from the submenu or by horizontally pushing the manual actuating device 3.

If, for example, in the screen display 2 illustrated in FIG. 5b, the manual actuating device 3 is pushed in the negative x direction, i.e. in the direction of the path on which the submenu 230.4 has been activated and opened, the submenu 230.5 is exited and the submenu 230.4 is activated again. The cursor is then positioned, for example on the entry from which it was activated, i.e. on the option 3 in the submenu 230.4. The display on the screen display 2 then corresponds again to the display in FIG. 5a.

If in the screen display 2 illustrated in FIG. 5b the manual actuating device 3 is pushed in the positive x direction, both the second submenu 230.5 and the first submenu 230.4 are exited and closed and the display area 240 from which the first submenu 230.4 was activated is activated again. The cursor is then positioned, for example, on the entry from which the first submenu 230.4 was activated, i.e. on the entry SubF 3 in the display area 240. This display on the screen display 2 is shown in FIG. 5c.

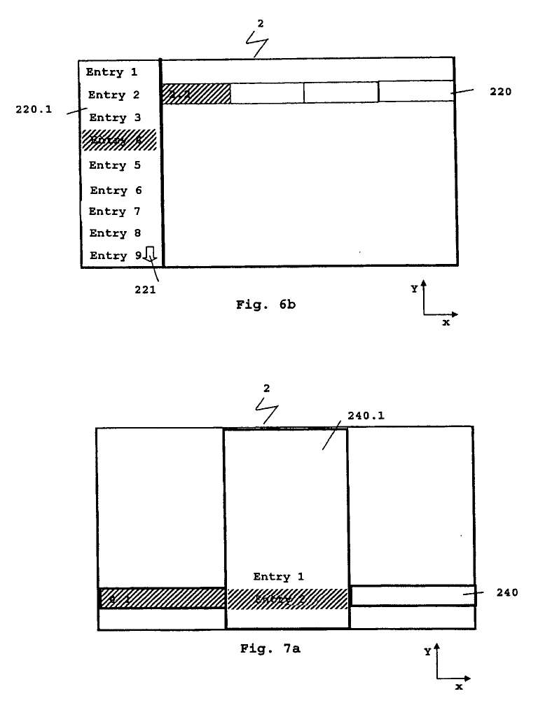

FIGS. 6a to 8c show various further forms of display of activated submenus on the screen display 2.

FIG. 6a shows a display area 220.1 which is opened by activating the entry 2.2 in the second display area 220. The submenu which is displayed in the display area 220.1 comprises two entries Ein1 and Ein2 in FIG. 6a. The displayed entry list of the submenu is, as is apparent from FIG. 6b, filled in from top to bottom if a plurality of entries Ein1 to Ein9 are present. An arrow 221 indicates that there are even more entries in the submenu list which can be selected.

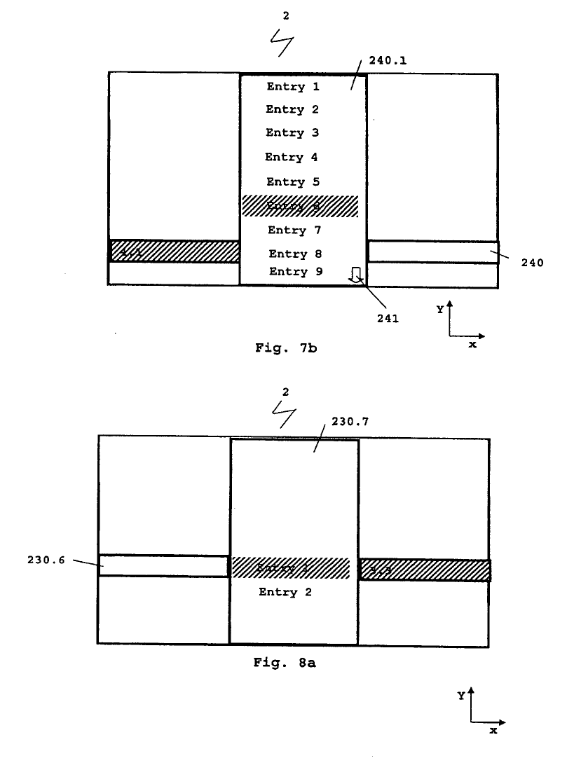

FIG. 7a shows a display area 240.1 which is opened by activating the entry 4.1 in the fourth display area 240. The submenu displayed in the display area 240.1 comprises two entries 1 and 2 in FIG. 7a. The displayed entry list of the submenu is, as is apparent from FIG. 7b, filled in from bottom to top if a plurality of entries 1 to 9 are present. An arrow 241 indicates that even more entries which can be selected are present in the submenu list.

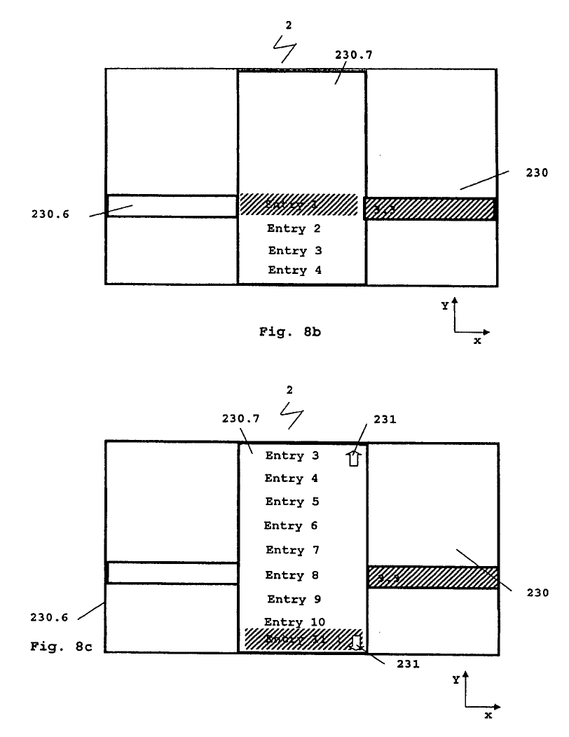

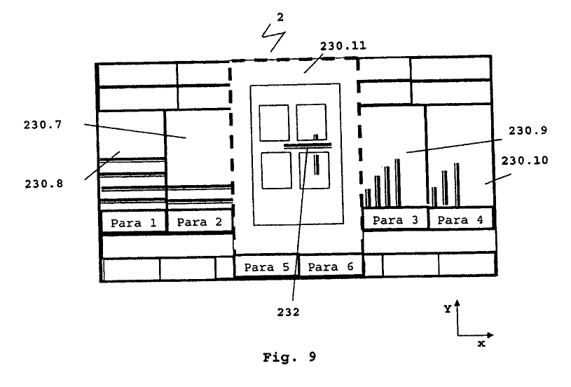

FIG. 8a shows a display area 230.7 which has been opened by activating the entry 3.3 from a first submenu 230.6 in the third display area 230. The second submenu displayed in the display area 230.7 comprises two entries 1 and 2 in FIG. 8a. The displayed entry list of the second submenu 230.7 is, as is apparent from FIG. 8b, firstly filled in from top to bottom from a vertical position of the activating entry 3.3 of the submenu 230.6 until all the possible fields in the downwards direction are filled with entries 1 to 4, then, the list is filled in from bottom to top, as shown in FIG. 8c, if a plurality of entries 3 to 11 are present. Arrows 231 indicate that even more entries which can be selected are present in the submenu list.

FIG. 9 shows, for example, various display areas 230.7 to 230.11 for setting parameters in the third display area 230. Two display areas 230.7 and 230.8 are used to set vertically arranged parameters Para 1 and Para 2. Two display areas 230.9 and 230.10 serve to set horizontally arranged parameters Para 3 and Para 4. The parameters Para 1 to Para 4 represent, for example, sound functions such as base, tones, volume etc. in an audio application. The display area 230.11 serves for simultaneously setting two parameters Para 5 and Para 6. Because this setting is implemented as cross hairs 232, the current value of the parameter Para 5 is displayed by the horizontally arranged bar and the current value of the parameter Para 5 is displayed by the vertically arranged bar. The parameter Para 5 is set by rotating or vertical pushing, and the parameter Para 6 by horizontal pushing of the manual actuating means 3. The parameters Para 5 and Para 6 represent, for example, Balance and Fade sound functions in the audio application. This menu is exited by pressing the manual actuating device 3 again. When setting a parameter, the currently set parameter values are stored by pressing the manual actuating device 3 and the activated display area 230.11 is exited.

The configurations described with respect to the drawings show that the invention can be used to control a very wide variety of applications and/or functions. The inventive assignment of the degrees of freedom of adjustment of the manual actuating means, remains the same over the various menu levels, for the purpose of orientating the arrangement of the entries in the respective active display area and the restricted number of degrees of freedom of adjustment allows the user to know intuitively how he can select and activate an entry in the respective active display area or exit the active display area. As a result, the control processes are simplified for the user and the cognitive load is reduced so that the user can concentrate better on the events on the road.

1.-29. (canceled)

30. A control system for a motor vehicle, comprising:
a manual actuating device with a plurality of degrees of freedom of adjustment for one of selecting and activating entries in a menu structure with a plurality of menu levels and
a screen display having a plurality of display areas for displaying the menu structure, the display areas each comprising
at least one field for displaying one of the entries, and, in an active display area in at least one menu level, at least one of a first and a second of the plurality of degrees of freedom of adjustment of the manual actuating device for at least one of selecting and activating one of the entries corresponding to an orientation of the entries displayed in an active display area, and
at least one of a third and a fourth degree of freedom of adjustment of the manual actuating device for exiting the active display area which is respectively orthogonal to the orientation of the displayed entries.

31. The control system as claimed in claim 30, further including at least one of a fifth and sixth degree of freedom of adjustment of the manual actuating means for redundantly selecting the at least one entry displayed in the active display area.

32. The control system as claimed in claim 30, wherein the fields with the entries are arranged at least one of with a vertical orientation in a y direction and with a horizontal orientation in an x direction in the individual display areas.

33. The control system as claimed in claim 32, wherein, when the entries are oriented vertically in the active display area,
the first degree of freedom of adjustment results from pushing the manual actuating device in the positive y direction,
the second degree of freedom of adjustment results from pushing the manual actuating device in the negative y direction,
the third degree of freedom of adjustment results from pushing the manual actuating device in the positive x direction,
the fourth degree of freedom of adjustment results from pushing the manual actuating device in the negative x direction,
the fifth degree of freedom of adjustment results from rotating the manual actuating device in the clockwise direction about a z axis which is perpendicular to the xy plane, and
the sixth degree of freedom of adjustment results from rotating the manual actuating device in the counter clockwise direction about the z axis.

34. The control system as claimed in claim 32, wherein, when the entries are arranged horizontally in the active display area,
the first degree of freedom of adjustment results from pushing the manual actuating device in the positive x direction,
the second degree of freedom of adjustment results from pushing the manual actuating device in the negative x direction,
the third degree of freedom of adjustment results from pushing the manual actuating device in the positive y direction,
the fourth degree of freedom of adjustment results from pushing the manual actuating device in the negative y direction,
the fifth degree of freedom of adjustment results from rotating the manual actuating device in the clockwise direction about a z axis which is perpendicular to the xy plane, and
the sixth degree of freedom of adjustment of the manual actuating device results from rotating the manual actuating device in the counter clockwise direction about the z axis.

35. The control system as claimed in one of claim 30, wherein, the activation of that selected entry of the active display area which is assigned to an application or a function or a subfunction or an option is carried out by means of a seventh degree of freedom of adjustment of the manual actuating device.

36. The control system as claimed in one of claim 30, wherein, the activation of that entry in one of the display areas which is assigned to a status display is carried out as a function of a current system state which is determined by a control and evaluation unit and is determined by evaluating signals of vehicle systems.

37. The control system as claimed in one of claim 32, wherein, when there are a plurality of entries in a display area, the width of the individual fields when the entries are arranged horizontally is dependent on the length of the respective entry, and when the entries are arranged vertically said width is dependent on the length of the longest entry.

38. The control system as claimed in one of claim 32, wherein, the field width when the entries are arranged horizontally is dependent on the number of entries to be displayed in this display area.

39. The control system as claimed in one of claim 30, wherein, the screen display has at least a first display area with a constant graphic basis structure over all the menu levels of the menu structure.

40. The control system as claimed in one of claim 30, wherein, the screen display has at least a second display area with a graphic basis structure which is variable as a function of an active menu level of the menu structure.

41. The control system as claimed in claim 39, wherein, in order to display a first menu level of the menu structure on the screen display, a plurality of separate, vertically arranged display areas, at least one of which can be activated, are provided.

42. The control system as claimed in one of claim 39, wherein, when an entry of an active display area is activated in the individual menu levels of the menu structure, a submenu which is dependent on the activated entry is opened in at least one further level of the menu structure, and by activating at least one of the display areas it can be displayed in said area.

43. The control system as claimed in claim 42, wherein, an opened submenu can be displayed in the active display area and in at least one other of the display areas by means of an overlap of the graphic basic structure.

44. The control system as claimed in claim 42, wherein, a plurality of the submenus are displayed simultaneously on the screen display in the at least one further submenu of the menu structure.

45. The control system as claimed in claim 44, wherein, the plurality of submenus can be displayed with entries orientated vertically one next to the other.

46. The control system as claimed in claim 43, wherein, a first of the plurality of submenus is opened and displayed in the first menu level of the menu structure as a function of an activation of an entry, and a second of the plurality of submenus is opened and displayed as a function of an activation of an entry in the associated first submenu.

47. The control system as claimed in claim 46, wherein, all the opened submenus are closed simultaneously by means of a pushing movement of the manual actuating device orthogonally with respect to the orientation of the entries of the active submenu away from the adjacent submenu, and in that only the active submenu is closed by means of a pushing movement of the manual actuating device orthogonally with respect to the orientation of the entries of the active submenu in the direction of the adjacent submenu, and the adjacent submenu is activated for a new selection of an entry.

48. The control system as claimed in one of claim 41, wherein, at least one of the number and the graphic display and contents of the entries to be displayed in the display areas are one of variable and constant as a function of one of current system states and of a current menu level and of a currently activated application.

49. The control system as claimed in claim 48, wherein, a presettable application can be displayed in at least one of the first display areas, the number and the position of the entries to be displayed being constant as a function of the preset application, and the contents and the graphic display of the entries to be displayed being one of variable and constant as a function of current system states.

50. The control system as claimed in claim 48, wherein, at least one of the first display areas is configured as a status bar with at least one horizontally arranged field for displaying at least one status, the number, the position, the contents and the graphic display of the entries to be displayed being variable as a function of current system states and application states.

51. The control system as claimed in claim 48, wherein, at least one of the first display areas is configured as an application line for displaying an application group with various selectable and predefinable applications, the number and position of the entries to be displayed being constant, and the graphic display of the entries to be displayed being variable as a function of an activated application.

52. The control system as claimed in claim 48, wherein, at least one of the second display areas is configured as an application area for displaying details and controlling a selected and activated application, the number and the position and the graphic display of the entries to be displayed being dependent on the activated application.

53. The control system as claimed in claim 48, wherein, at least one of the first display areas is configured as a subfunction line for displaying and selecting at least one of functions and subfunctions and options of an activated application, the number and the position and the graphic display of the entries to be displayed being dependent on the activated application.

54. The control system as claimed in one of claim 30, wherein, a cursor can be moved over the screen display by the manual actuating device in order to select at least one entry displayed on the screen display.

55. The control system as claimed in claim 54, wherein, a graphic display of the cursor is variable as a function of at least one of the active display area and of an active application and an active menu level.

56. The control system as claimed in claim 54, wherein, the cursor can be displayed graphically as an independent object on the screen display or by changing the graphic display of a currently selected field.

57. The control system as claimed in claim 56, wherein, a field which is selected with a cursor changes at least one of its colored display and its shape and its size.

58. The control system as claimed in claim 56, wherein, at least one of a colored display and a shape and a size of the cursor can be changed as an independently graphically displayed object on the screen.
